(19) United States
(12) Patent Application Publication
(10) Pub. No.: US 2023/0161823 A1
(43) Pub. Date: May 25, 2023

(54) SERVICE TASK EXECUTION METHOD AND APPARATUS, AND COMPUTER-READABLE STORAGE MEDIUM

(71) Applicant: ENNEW DIGITAL TECHNOLOGY CO., LTD, Langfang (CN)

(72) Inventor: Jie Yang, Langfang (CN)

(21) Appl. No.: 18/157,086

(22) Filed: Jan. 20, 2023

Related U.S. Application Data
(63) Continuation of application No. PCT/CN2021/101318, filed on Jun. 21, 2021.

(30) Foreign Application Priority Data
Dec. 31, 2020 (CN) 202011635733.4

(51) Int. Cl. G06F 16/906

(52) U.S. Cl. CPC G06F 16/906

(57) ABSTRACT

A service task execution method and apparatus, and a computer-readable storage medium and an electronic device. The method comprises: clustering a plurality of pieces of non-label data corresponding to a service task of a target user, so as to determine at least two cluster center points (101); according to the at least two cluster center points and the plurality of pieces of non-label data, determining weights corresponding to a plurality of pieces of label data of a joint user, wherein the plurality of pieces of label data correspond to the service task (102); and according to the plurality of pieces of label data of each joint user and the weights corresponding to the plurality of pieces of label data, constructing a joint learning model, wherein the joint learning model is used for executing the service task of the target user (103).

### CROSS REFERENCE TO RELATED APPLICATIONS

The present application is a Continuation Application of PCT Application No. PCT/CN2021/101318 filed on Jun. 21, 2021, which claims the benefit of Chinese Patent Application No. 202011635733.4 filed on Dec. 31, 2020. All the above are hereby incorporated by reference in their entirety.

### TECHNICAL FIELD

The present application relates to that technical field of energy, in particular to a method and a device for business task execution and a computer-readable storage medium.

### BACKGROUND

As a new concept of machine learning, joint learning ensures that users' private data are protected to the maximum extent through distributed training and encryption technology, so as to enhance the users' trust in artificial intelligence technology. Under the joint learning mechanism, the joint learning server initializes a global model and sends it to each user as an initial model. Users train local models according to their own data, and then upload the local models to the joint learning server. The joint learning server aggregates the local models and then sends them to each user as an initial model training. This iteration is carried out until the model converges, and finally the global model is obtained. By combining the data information of each user, the accuracy of the global model can be improved without local data.

At present, firstly, the global model of a target user is obtained through joint learning, and then the global model is fine-tuned according to the local data of the target user to obtain a model suitable for the target user.

However, fine-tuning the global model needs to use the label data of the target user. However, in many application scenarios, the label data of the target user is difficult to obtain, which makes it difficult to use this method.

### SUMMARY

The present application provides a method and a device for business task execution, a computer-readable storage medium and electronic equipment, which can transfer non-label data to label data by the weight of the label data on the premise that the target user does not have a label, so as to ensure that the business task of the target user can be realized.

In a first aspect, the present application provides a business task execution method, including the following steps of:
clustering a plurality of non-label data corresponding to a business task of a target user, so as to determine at least two clustering center points;
determining respective weights corresponding to a plurality of label data of a joint user according to the at least two clustering center points and the plurality of non-label data, wherein the plurality pieces of label data correspond to the business task;
constructing a joint learning model according to the plurality of label data of each joint user and the respective weights corresponding to the plurality of label data, wherein the joint learning model is used for executing the business task of the target user.

In a second aspect, the present application provides a business task execution device, including:
a clustering module configured to cluster a plurality of non-label data corresponding to a business task of a target user to determine at least two clustering center points;
a weight determination module configured to determine respective weights of a plurality of label data of a joint user according to the at least two clustering center points and the plurality of non-label data, wherein the plurality of label data correspond to the business task;
a construction module configured to construct a joint learning model according to the plurality of label data of the joint user and the respective weights of the plurality of label data, wherein the joint learning model is used for executing the business task of the target user.

In a third aspect, the present application provides a computer-readable storage medium, including execution instructions, wherein when a processor of an electronic equipment executes the execution instructions, the processor executes the method according to any one of the first aspects.

In a fourth aspect, the present application provides an electronic equipment including a processor and a memory storing execution instructions, wherein when the processor executes the execution instructions stored in the memory, and the processor executes the method according to any one of the first aspects.

The present application provides a method and a device for business task execution, a computer readable storage medium and electronic equipment. In this method, two or more clustering center points are determined by clustering a plurality of non-label data corresponding to the business task of a target user. Then, according to the two or more clustering center points and a plurality of non-label data, weights corresponding to the plurality of label data of a joint user are determined, and the plurality of label data correspond to the business task. Then, according to the plurality of label data and the weights corresponding to the plurality of label data of the joint user, a joint learning model which is used for executing the business task of the target user is constructed. To sum up, through the technical solution of the present application, under the premise that the target user does not have a label, the non-label data can be migrated to the label data by the weight of the label data, thus ensuring that the business task of the target user can be realized.

The further effects of the above unconventional preferred mode will be described below in connection with the specific embodiments.

### BRIEF DESCRIPTION OF DRAWINGS

In order to more clearly explain the embodiments of the present application or the existing technical solutions, the drawings used in the description of the embodiments or the prior art will be briefly introduced below. Obviously, the drawings in the following description are only some of the embodiments recorded in the present application, and for those skilled in the art, other drawings can be obtained according to these drawings without paying any creative effort.

FIG. 1 is a flow diagram of a business task execution method provided by an embodiment of the present application;

FIG. 2 is a schematic structural diagram of another business task execution method provided by an embodiment of the present application;

FIG. 3 is a schematic structural diagram of a business task execution device according to an embodiment of the present application;

FIG. 4 is a structural diagram of electronic equipment according to an embodiment of the present application.

### DESCRIPTION OF EMBODIMENTS

In order to make the purpose, technical solution and advantages of the present application clearer, the technical solution of the present application will be clearly and completely described below with specific examples and corresponding drawings. Obviously, the described embodiments are only part, not all of the embodiments of the present application, not all of them. Based on the embodiments in the present application, all other embodiments obtained by those skilled in the art without creative work are within the scope of the present application.

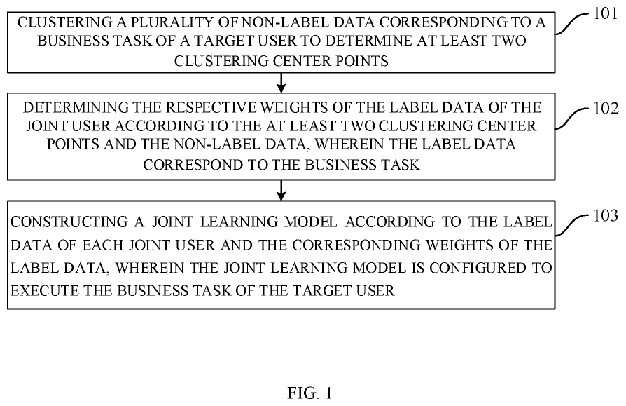

FIG. 1 shows a business task execution method according to an embodiment of the present application. The method provided by the embodiment of the present application can be applied to electronic equipment, specifically to servers or general computers. In this embodiment, the method specifically includes the following steps:
step 101, clustering a plurality of non-label data corresponding to a business task of a target user to determine at least two clustering center points.

A target user refers to equipment with business requirements, which can be energy equipment, such as gas-fired steam boilers, photovoltaic power plants, gas-fired internal combustion engines, gas turbines and so on.

A business task refers to the ultimate goal of the target user, such as failure prediction, prediction of remaining service life of the equipment, variable prediction and so on.

Non-label data refers to feature data without labels, the feature data is a one-dimensional line vector, and the line vector includes feature values corresponding to multiple features, among which features refer to influencing factors of the business task. It should be understood that a plurality of non-label data have sequence numbers, and multiple features corresponding to each non-label data are the same, and multiple features have sequence numbers. In practical application, the i^{th} non-label data is represented as [x_{i,1}, x_{i,2}, . . . , x_{i,j-1}, x_{i,j}], where x_{i,j} represents the feature value corresponding to the j^{th} feature in the i^{th} non-label data, and other data items have similar meanings, and thus will not be described repeatedly.

Specifically, a plurality of non-label data are clustered by a clustering algorithm, so as to determine two or more clustering center points, wherein, the clustering algorithm can be k-means clustering, hierarchical clustering algorithm or density clustering, and k-means clustering is preferred. In some possible cases, the clustering center point is different from any non-label data among a plurality of non-label data, thus ensuring data security. Specifically, a plurality of non-label data are clustered by a clustering algorithm to determine a plurality of clusters. For each cluster, the mean value of a plurality of non-label data in the cluster is calculated. When the calculated mean value is non-label data, the mean value and the mean value between non-label data closest to the mean value are determined as the clustering center point.

Step 102: determining the respective weights of the label data of the joint user according to the at least two clustering center points and the non-label data, wherein the label data correspond to the business task.

In this embodiment, the weights corresponding to a plurality of label data of the joint user are determined through two or more clustering center points and a plurality of non-label data, and the non-label data is migrated to the label data on the premise that the target user does not have a label, so as to ensure that the business task of the target user can be realized.

Understandably, label data refers to feature data with labels, and many features corresponding to label data and non-label data are the same, so that lateral joint learning can be carried out between target users and joint users, wherein, the label is related to the business task. For example, if the business task is fault prediction, the label can be of a fault type, if the business task is flue gas oxygen content prediction, the label can be flue gas oxygen content, and if the business task is the remaining service life of the equipment, the label can be the remaining service life of the equipment. In practical application, the i^{th} label data is expressed as [x_{i,1}, x_{i,2}, . . . , x_{i,j-1}, x_{i,j}, yᵢ], where x_{i,j} represents the feature value corresponding to the j^{th} feature in the i^{th} label data, yᵢ represents the lable corresponding to the i^{th} tag data, and other data items have similar meanings, and thus will not be described repeatedly.

Specifically, the weight of the label data refers to the importance of the label data relative to the non-label data, thus migrating the non-label data to the label data.

In some possible embodiments, step 102 includes:
determining the target similarity between each of the at least two clustering center points and the plurality of non-label data according to the at least two clustering center points and the plurality of non-label data;
determining the respective similarity weights corresponding to the at least two clustering center points according to the at least two clustering center points, the target similarity between each of the at least two clustering center points and the plurality of non-label data and the plurality of label data of the joint user; and
determining the respective weights corresponding to the plurality of label data of the joint user according to the respective similarity weights corresponding to the at least two clustering center points.

In this embodiment, by determining the target similarity between the clustering center point and the plurality of non-label data, and based on the clustering center points and the target similarity between the clustering center points and the plurality of non-label data, the similarity weight corresponding to the clustering center point is determined, and based on the similarity weight corresponding to each of the clustering center points, the weight corresponding to the plurality of label data of the joint user is determined, which does not involve the interaction between the non-label data and the label data, thus ensuring the data security. At the same time, the similarity between the clustering center point and the target can represent the relationship between a plurality of non-label data, thus ensuring the reference values of the respective weights of the plurality of label data, and the obtained weights comprehensively consider the similarity weights corresponding to the clustering center points, and have relatively high accuracy, wherein the similarity weight corresponding to the clustering center points indicates the importance of the similarity between the clustering center points and the label data of the joint user.

Optionally, for each clustering center point, based on the similarity between each non-label data and the clustering center point, the similarity between each non-label data and the clustering center point is averaged to obtain the target similarity between the clustering center point and each of the non-label data, that is, the target similarity is obtained by averaging the target similarity between each of the non-label data and the clustering center point.

Specifically, the similarity between the clustering center point and the non-label data can be determined by any existing similarity calculation method, for example, the distance between the clustering center point and the non-label data can be calculated and determined as the similarity, or a kernel function value between the clustering center point and the label data can be calculated and determined as the similarity by a kernel function. In other words, the similarity between the non-label data and the clustering center points can be calculated by a kernel function, wherein the kernel function can be any kernel function in the prior art, such as a polynomial kernel function, a linear kernel function, a radial basis kernel function and an exponential kernel function, and a Gaussian kernel function in radial basis kernel functions is preferred. Specifically, the target similarity between the clustering center point and the plurality of non-label data can be calculated by the following Formula 1; the Formula 1 includes:

$${\hat{h}}_{l} = \frac{1}{n} {\sum }_{i = 1}^{n} K ( {x}_{i} , {x}_{l} )$$

where, ĥᵢ represents a target similarity between the l^{th} clustering center point and a plurality of non-label data; n represents the number of data in the plurality of non-label data; xᵢ represents the i^{th} non-label data; xₗ represents the l^{th} clustering center point; K(·) represents a kernel function. It should be understood that the kernel function value calculated based on the kernel function K(·) is understood as the similarity between the clustering center point and the non-label data. A Gaussian kernel function is preferred.

Optionally, for each label data of the joint user, according to the similarity weight corresponding to each of the at least two clustering center points, the similarity between each of the at least two clustering center points and the label data is weighted and summed to determine the weight corresponding to the label data. Specifically, the weight of the label data can be calculated by the following Formula 6; wherein, the Formula 6 is as follows:

\hat{r}(xⱼ)_{α}=Σₗ₌₁^{k}\hat{θ}ₗK(xⱼ, xₗ)

where, \hat{r}(xⱼ)_{α} represents the weight of the j^{th} label data; xⱼ represents the j^{th} label data; xₗ represents the l^{th} clustering center point; \hat{θ}ₗ represents the similarity weight corresponding to the l^{th} clustering center point; k represents the number of the clustering center points; K(·) represents a kernel function. Here, the sum of the similarity weights of k clustering center points is equal to 1.

Specifically, according to the at least two clustering center points, the target similarity between each of the at least two clustering center points and the non-label data, and the label data of the joint user, the similarity weights corresponding to the at least two clustering center points can be determined in the following two ways.

Implementation 1: according to the at least two clustering center points and a plurality of label data of the joint user, the reference similarity between the at least two clustering center points and the plurality of label data is determined; for each clustering center point, a ratio of the target similarity between the clustering center point and the plurality of non-label data to the reference similarity between the clustering center point and the plurality of label data is calculated, and the ratio is determined as the similarity weight corresponding to the clustering center point. It should be noted that the calculation methods of the target similarity and reference similarity are the same, and the only difference is that the target similarity is non-label data for the target user, and the reference similarity is label data for the joint user.

Implementation 2: according to the at least two clustering center points and the plurality of non-label data, the initial correlation between any two clustering center points in the at least two clustering center points is determined;

the reference correlation between the any two clustering center points is determined according to the any two clustering center points and the plurality of label data of the joint user; the target correlation between the any two clustering center points is determined according to the initial correlation and reference correlation between the any two clustering center points; the similarity weight corresponding to each of the at least two clustering center points is determined according to the target correlation between any two clustering center points and the target similarity between each of the at least two clustering center points and the plurality of non-label data.

In the implementation 2, the target correlation corresponding to any two clustering center points is determined by the reference correlation of any two clustering center points corresponding to a plurality of label data of the joint user and the initial correlation of any two clustering center points corresponding to a plurality of non-label data of the target user. The target correlation is configured to characterize the data correlation degree between the target user and the joint user. Then, based on the target correlation between any two clustering center points and the target similarity between each of all clustering center point clustering center point points and a plurality of non-label data of the joint user, the similarity weights corresponding to all clustering center points are determined. Understandably, the obtained similarity weight comprehensively considers the clustering center points, the target similarity between the clustering center point clustering center point and a plurality of non-label data, the initial correlation and the reference correlation between any two clustering center points, and has relatively high accuracy, wherein, the initial correlation between two clustering center points indicates the degree of correlation between the two clustering center points corresponding to a plurality of non-label data of the target user. The larger the initial correlation, the greater the correlation between the two clustering center points corresponding to the non-label data. The reference correlation between two clustering center points indicates the correlation degree of two clustering center points corresponding to a plurality of label data of the joint user.

In the implementation 2, optionally, the initial correlation is obtained by correcting the average value of the respective target similarity product values corresponding to the non-label data based on the target probability distribution weight, and the target similarity product values are obtained by multiplying the target similarity between each of the any two clustering center points and the non-label data. In practical application, the target similarity between each of any two clustering center points and the same non-label data is calculated, and the target similarities between any two clustering center points and the same non-label data are multiplied to obtain the target similarity product value. Then, the target similarity product values corresponding to a plurality of non-labeled data are obtained, and the target similarity product values corresponding to a plurality of non-labeled data are averaged to obtain an average result. Based on the target probability distribution weight, the average result is corrected to obtain the initial correlation corresponding to the clustering center. Specifically, the initial correlation between any two clustering center points can be calculated by the following Formula 2; wherein, the Formula 2 includes:

$${\hat{H}}_{l , {l}^{′}}^{a} = \frac{α}{n} {\sum }_{i = 1}^{n} K ( {x}_{i} , {x}_{l} ) K ( {x}_{i} , {x}_{{l}^{′}} )$$

where, Ĥ_{l,l′}^{α} represents the initial correlation between the l^{th} clustering center point and the l′^{th} clustering center point; n represents the number of data of each non-label data; xᵢ represents i^{th} non-label data; xₗ represents the l^{th} clustering center point; x_{l′} represents the l′^{th} clustering center point; α represents the target probability distribution weight; K(·) represents a kernel function.

Correspondingly, the reference correlation is obtained by correcting the average value of the reference similarity product values corresponding to each of the label data based on the reference probability distribution weight, and the reference similarity product values are obtained by multiplying the reference similarity between each of the any two clustering center points and the label data. In practical application, the reference correlation between any two clustering center points is calculated by the following Formula 3, wherein, the Formula 3 includes:

$${\hat{H}}_{l , {l}^{′}}^{b} = \frac{1 - α}{m} {\sum }_{j = 1}^{m} K ( {x}_{j} , {x}_{l} ) K ( {x}_{j} , {x}_{{l}^{′}} )$$

where Ĥ_{l,l′}^{b}, represents the reference correlation between the l^{th} clustering center point and the l′^{th} clustering center point; xⱼ represents the j^{th} label data of the joint user; m represents the number of data of each label data of the joint user; 1−α represents the reference probability distribution weight and a represents the target probability distribution weight.

It should be understood that the target probability distribution weight indicates the importance of the probability distribution of a plurality of non-label data of the target user, and as a possible implementation, it can be set artificially according to actual needs. As another possible case, the target probability distribution weight can be determined in the following way:
acquiring a plurality of verification data corresponding to the plurality of non-label data and a preset probability distribution weight;
according to the preset probability distribution weight and the plurality of verification data, determining respective verification weights corresponding to the plurality of verification data;
determining the error data corresponding to the preset probability distribution weight according to the respective weight labels corresponding to the verification data and the respective verification weights corresponding to the verification data;
determining the target probability distribution weight according to the error data corresponding to each preset probability distribution weight.

In this embodiment, the same method is adopted to determine the weights corresponding to a plurality of label data of the joint user, and the verification weights corresponding to multiple verification data are determined by preset probability distribution weights; then, the weight labels corresponding to multiple verification data and the verification weights corresponding to multiple verification data are judged, the error data corresponding to the preset probability distribution weights are determined, and the accuracy of the preset probability distribution weights is judged based on the error data. The preset probability distribution weight with the highest accuracy is determined as the target probability distribution weight, so as to ensure the accuracy of the weights corresponding to a plurality of label data of the joint user determined based on the target probability distribution weight. Here, the multiple verification data can be other non-label data of the business task of the target user, or a plurality of label data of the business task of the joint user, which needs to be determined according to the actual situation. The error data can be parameters for evaluating the error, such as the standard deviation and variance of the difference between the weight labels corresponding to multiple verification data and the verification weights, which is not specifically limited here. It should be understood that the method of determining the verification weight of the verification data is the same as that of determining the weight of label data of the joint user.

In the implementation 2, as a possible case, according to the target correlation between any two clustering center points and the target similarity between each of the at least two clustering center points and the plurality of non-label data, the similarity weight corresponding to each of the at least two clustering center points is determined in the following way:
determining a target correlation matrix corresponding to at least two clustering center points according to the target correlation between any two clustering center points; determining a target similarity vector according to the target similarity between each of the at least two clustering center points and the plurality of non-label data; according to the regularization parameter and identity matrix, correcting the target correlation matrix to determine the correction correlation matrix; determining a similarity weight vector according to the correction correlation matrix and the target similarity vector, wherein the similarity weight vector comprises the respective similarity weights corresponding to the at least two clustering center points.

Understandably, in order to prevent over-fitting, the correlation matrix is modified by regularization parameters and identity matrix, and the correction correlation matrix is determined. Then, according to the correction correlation matrix and similarity vector, the similarity weight vector is determined, so that the corresponding similarity weight of each clustering center point can be obtained.

Specifically, the result obtained by multiplying the regularization parameter and the similarity vector is added with the correlation matrix to obtain a correction correlation matrix, and then the reciprocal of the correction correlation matrix is multiplied with the similarity vector to obtain the similarity weight vector. In practical application, the correction correlation matrix is calculated by the following Formula 4; the Formula 4 includes:

Ĥ′=Ĥ+λIₙ

where Ĥ′ represents the correction correlation matrix; Ĥ represents the correlation matrix; λ represents the regularization parameter; Iₙ represents the identity matrix.

The similarity weight vector is calculated by the following Formula 5; the Formula 5 includes:

\hat{θ}=Ĥ′⁻¹ĥ

wherein \hat{θ} represents a similarity weight vector; A′ represents the correction correlation matrix; ĥ represents the target similarity vector.

It should be noted that the number of clustering center points in the target correlation matrix is the same as that in the target similarity vector. It should be understood that the number of clustering center points indicates the order of the clustering center points.

Specifically, the matrix elements in the target correlation matrix comprehensively consider the initial correlation and reference correlation between two clustering center points, which ensures the reference value of the correlation matrix. Specifically, the target relevance can be determined by the following two ways.

Implementation 1, the target correlation is obtained by adding the initial correlation and the reference correlation between any two clustering center points. Specifically, two or more clustering center points are numbered, a two-dimensional matrix is constructed, the initial correlation and reference correlation between any two clustering center points are put into the two-dimensional matrix as elements, and the sum of the initial correlation and reference correlation between any two clustering center points is calculated to obtain the target correlation matrix. It should be understood that different joint users each calculate the target correlation of any two clustering center points.

It should be understood that the core idea in this embodiment is to calculate the probability distribution ratio w(x) of the probability distribution p(x) of the target user and the probability distribution q(x) of each joint user, so as to set the weight for the label data of the joint user. The calculation process of multiple joint users is the same. Here, taking one joint user as an example, it is assumed that a plurality of non-label data are expressed as {xᵢ}ᵢ₌₁ⁿ, wherein, n represents the number of data of the non-label data, and a plurality of label datal of the joint user are expressed as {xⱼ}ⱼ₌₁^{m}, wherein, m represents the number of data of the label data.

Let w(x)=\hat{r}(x)_{α}, \hat{r}(x)_{α}=p(x)/(αp(x)+(1−α)q(x)), a regression model is constructed based on the idea of linear combination of similarity between data and several clustering points, and let \hat{r}(x)_{α}=Σᵢ₌₁^{k}\hat{θ}ₗK(x, xₗ), where K(x, xₗ) represents a kernel function, and then the loss function

$$\hat{θ} = arg min [ \frac{1}{2} {θ}^{T} \hat{H} θ - {\hat{h}}^{T} θ + \frac{λ}{2} {θ}^{T} θ ]$$

is minimized, wherein θ has an analytical solution, \hat{θ}=(Ĥ+λIₙ)⁻¹ĥ, wherein, λ represents a regularization parameter; Iₙ represents an identity matrix, ĥ represents a vector; Ĥ represents a matrix. Each element in Ĥ is represented as follows:

$${\hat{H}}_{l , {l}^{′}} = \frac{α}{n} {\sum }_{i = 1}^{n} K ( {x}_{i} , {x}_{l} ) K ( {x}_{i} , {x}_{{l}^{′}} ) + \frac{1 - α}{m} {\sum }_{j = 1}^{m} K ( {x}_{j} , {x}_{l} ) K ( {x}_{j} , {x}_{{l}^{′}} )$$

wherein, Ĥ_{l,l′} represents a matrix element in the intersection position of the l^{th} row and the l′^{th} column; n represents the number of data of each non-label data; xᵢ represents the i^{th} non-label data; xₗ represents the clustering center point of the l^{th} cluster; x_{l′} represents the clustering center point of the l′^{th} cluster; α represents the target probability distribution weight; K(·) represents a kernel function; xⱼ represents the j^{th} label data of the joint user; m represents the number of data of each label data of the joint user; 1−α represents the reference probability distribution weight.

The vector element in ĥ is represented as follows:

$${\hat{h}}_{l} = \frac{1}{n} {\sum }_{i = 1}^{n} K ( {x}_{i} , {x}_{l} )$$

where, ĥₗ represents the l^{th} element; n represents the number of data of each non-tag data; xᵢ represents the i^{th} non-tag data; xₗ represents the clustering center point of the l^{th} cluster; K(·) represents a kernel function.

The implementation 1 further includes:
determining the data distribution similarity between the target user and the joint user according to the non-label data, the at least two clustering center points and the similarity weights corresponding to the at least two clustering center points;
determining the respective importance of each joint user according to the data distribution similarity between each joint user and the target user;
adjusting the joint learning model according to the respective importance of each joint user.

Specifically, the data distribution similarity between the target user and joint user is calculated by the following Formula 7, wherein, the Formula 7 is as follows:

$${\hat{L}}_{s} = \frac{1}{n} {\sum }_{i = 1}^{n} log [ {\hat{θ}}_{l , s} K ( {x}_{i} , {x}_{l} ) ]$$

where \hat{L}ₛ represents the data distribution similarity between the target user and the first joint user, and \hat{θ}_{l,s} represents the similarity weight of the l^{th} clustering center point of the s^{th} joint user.

Specifically, the importance of the joint user is calculated by the following Formula 8:

$${Score}_{s} = \frac{{e}^{- \vert {\hat{L}}_{s} \vert}}{{\sum }_{s = 1}^{N} {e}^{- \vert {\hat{L}}_{s} \vert}}$$

where Scoreₛ represents the s^{th} joint user; N represents the number of the joint users.

In practical application, the predicted value that the target user will use for the joint learning model to predict and the true value corresponding to the predicted value are obtained. When the error between the predicted value and the true value is large, for example, greater than a preset threshold, at this time, the importance of the joint user can be determined based on the data distribution similarity between the target user and joint users, the joint users with a lower importance can be deleted, the users with a higher importance can be retained, and the joint learning model can be revised through joint learning by the joint users with higher importance. It is also possible to reward the joint users based on their importance, so that the joint users with higher importance can provide more label data, so as to modify the joint learning model and obtain a joint learning model with a higher accuracy.

Implementation 2: based on the initial correlation of target users and the respective reference correlations of different joint users, the shared target correlation is obtained, in other words, different joint users share the target correlation between any two clustering center points. In other words, all the joint users share the target correlation between any two clustering center points; the target correlation is determined based on the initial correlation between any two clustering center points and the reference correlation between any two clustering center points of each joint user.

Specifically, for any two clustering center points among all clustering center points, the target correlation can be the sum of the average of the reference correlations between any two clustering center points of each joint user and the initial correlations between any two clustering center points. In this embodiment, there is no specific limitation on how to obtain the target correlation, as long as the correlation is determined based on the initial correlations between any two clustering center points and the reference correlations between any two clustering center points of each joint user.

step 103: constructing a joint learning model according to the label data of each joint user and the corresponding weights of the label data, wherein the joint learning model is configured to execute the business task of the target user.

Specifically, for each joint user, the initial model is trained according to a plurality of label data of the joint user and their respective corresponding weights to obtain the local mode of the joint user. Then, local model of each joint user is sent to the target user, and the target user aggregates each joint user's local model to obtain an updated model. Then, the updated model is sent to each joint user as an initial model for training, and this iteration is carried out until the model converges, and finally the joint learning model is obtained. The obtained joint learning model is configured to perform business tasks, for example, when the business task is a fault-type prediction, the joint learning model is configured to predict the fault type of the target user.

It should be understood that the weights corresponding to the label data of the joint user are configured to adjust the model parameters in the model, so that the adjusted model can reflect the relationship between the non-label data of the target user and the business tasks, and ensure the model accuracy of the joint learning model. In practical application, the local model of the joint user can be determined by the following ways:

A1, according to the prediction results of substituting multiple feature data in the label data into the initial model and the labels corresponding to the multiple feature data in the label data, determining the first errors corresponding to the label data, and multiplying the first errors and weights corresponding to the plurality of label data to determine the second errors corresponding to the plurality of label data;

A2, judging whether the iteration times are met or whether the second errors corresponding to a plurality of label data meet the preset conditions, if so, determining the initial model as a local model, and if not, executing A3;

A3, adjusting the model parameters in the initial model according to the second errors corresponding to the label data to determine the adjusted model parameters, replacing the model parameters in the initial model with the adjusted model parameters, and executing A1.

It should be noted that the label data of each joint user is distributed in different nodes in the Internet of Things, and data sharing will cause data security problems. Through joint learning of the unshared data and the weights of the unshared data in the nodes, the local model of the nodes can be obtained, and the unshared data can be migrated to the target users, so that there is no data sharing among nodes, and the data security problems caused by direct sharing of data can be avoided, wherein, nodes can perform data processing and data interaction, including but not limited to any one or more of edge servers, edge gateways and edge controllers. The data interaction between the target user and the joint user only involves the similarity of the target, the initial correlation and the clustering center point, and does not involve the interaction of non-label data.

As a possible case, the similarity of data distribution between the joint user and the target user is not less than the preset threshold. Here, the data distribution similarity can be calculated based on the above Formula 7.

According to the above technical solution, this embodiment has the following beneficial effects: clustering a plurality of non-label data corresponding to the business tasks of the target users, determining the clustering center point, determining the clustering center point and a plurality of non-label data, determining the weight of the label data of the joint user, transferring the non-label data to the label data, realizing data migration and ensuring the data quantity; and then, constructing a joint learning model according to the label data of the joint user and the corresponding weights of the label data, wherein the joint learning model is configured to perform the business task of the target user, and can complete the business task of the target user on the premise that the target user lacks labels.

FIG. 1 shows only the basic embodiment of the method of the present application, and other preferred embodiments of the method can be obtained after some optimization and expansion.

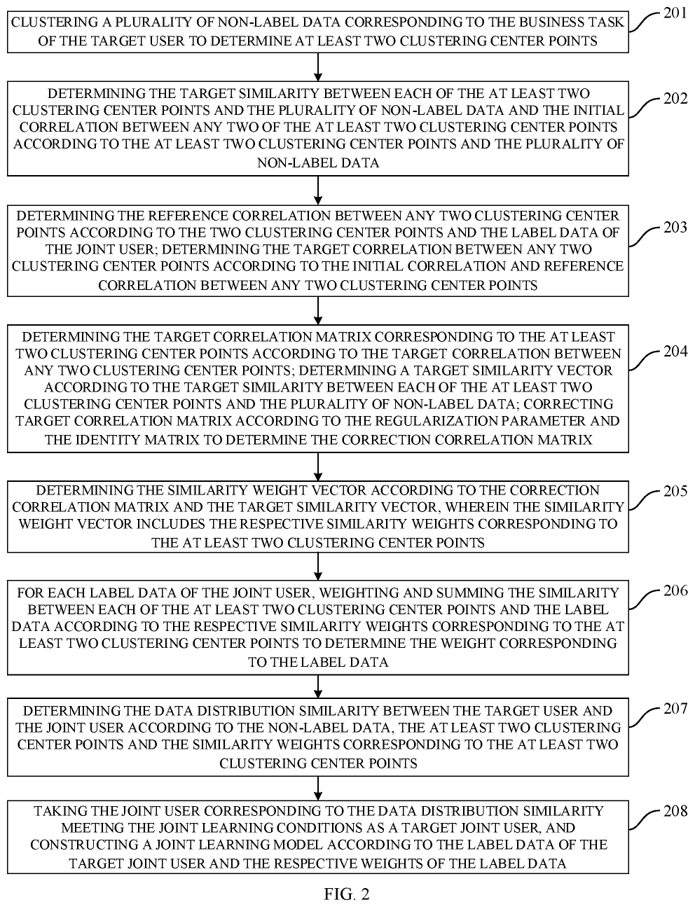

FIG. 2 shows another specific embodiment of the business task execution method according to the present application. Based on the previous embodiments, this embodiment is described in more detail in combination with application scenarios.

The specific scenario combined in this embodiment is that a plurality of non-label data of the target user is represented as {xᵢ}ᵢ₌₁ⁿ, wherein n represents the number of non-label data, and a plurality of label data of the joint user is represented as {xⱼ}ⱼ₌₁^{m}, wherein m represents the number of label data. The calculation process of multiple joint users is the same. Here, only one joint user is taken as an example for illustration.

The method specifically comprises the following steps:

Step 201: clustering a plurality of non-label data corresponding to the business task of the target user to determine at least two clustering center points.

The target user clusters a plurality of non-label data by a K-means clustering algorithm, and obtains k clusters and the clustering center points of each cluster, each clustering center point is different from non-label data, which ensures data security and privacy.

Step 202: determining the target similarity between each of the at least two clustering center points and the plurality of non-label data and the initial correlation between any two of the at least two clustering center points according to the at least two clustering center points and the plurality of non-label data.

The target user calculates the target similarity between the clustering center points and a plurality of non-label data through the Formula 1,

$${\hat{h}}_{l} = \frac{1}{n} {\sum }_{i = 1}^{n} K ( {x}_{i} , {x}_{l} ) ,$$

and obtains the target similarity corresponding to each of k clustering center point, and k target similarities are expressed as ĥ₁, ĥ₂, . . . , ĥₗ, . . . , ĥₖ, where K(·) is a Gaussian kernel function.

The target user calculates the initial correlation between any two clustering center points by the above Formula 2,

$${\hat{H}}_{l , {l}^{′}}^{a} = \frac{α}{n} {\sum }_{i = 1}^{n} K ( {x}_{i} , {x}_{l} ) K ( {x}_{i} , {x}_{{l}^{′}} ) ,$$

and obtains k² initial correlations, which are represented by the following Table 1:

TABLE 1

| | 1 | 2 | . . . | l′ | . . . | k |
|---|---|---|---|---|---|---|
| 1 | Ĥ_{1, 1}^{a} | Ĥ_{1, 2}^{a} | . . . | Ĥ_{1, l′}^{a} | . . . | Ĥ_{1, k}^{a} |
| 2 | Ĥ_{2, 1}^{a} | Ĥ_{2, 2}^{a} | . . . | Ĥ_{2, l′}^{a} | . . . | Ĥ_{2, k}^{a} |
| . . . | . . . | . . . | . . . | . . . | . . . | . . . |
| l | Ĥ_{l, 1}^{a} | Ĥ_{l, 2}^{a} | . . . | Ĥ_{l, l′}^{a} | . . . | Ĥ_{l, k}^{a} |
| . . . | . . . | . . . | . . . | . . . | . . . | . . . |
| k | Ĥ_{k, 1}^{a} | Ĥ_{k, 2}^{a} | . . . | Ĥ_{k, l′}^{a} | . . . | Ĥ_{k, k}^{a} |

Step 203: determining the reference correlation between any two clustering center points according to the two clustering center points and the label data of the joint user; determining the target correlation between any two clustering center points according to the initial correlation and reference correlation between any two clustering center points.

The target user sends the target similarity corresponding to each of k clustering center points and k² initial correlations in Table 1 to the joint user, and the joint user calculates the reference correlations between any two clustering center points by the above Formula 3,

$${\hat{H}}_{l , {l}^{′}}^{b} = \frac{1 - α}{m} {\sum }_{j = 1}^{m} K ( {x}_{j} , {x}_{l} ) K ( {x}_{j} , {x}_{{l}^{′}} ) ,$$

and obtains k² reference correlations, which are represented by the following Table 2:

TABLE 2

| | 1 | 2 | . . . | l′ | . . . | k |
|---|---|---|---|---|---|---|
| 1 | Ĥ_{1, 1}^{b} | Ĥ_{1, 2}^{b} | . . . | Ĥ_{1, l′}^{b} | . . . | Ĥ_{1, k}^{b} |
| 2 | Ĥ_{2, 1}^{b} | Ĥ_{2, 2}^{b} | . . . | Ĥ_{2, l′}^{b} | . . . | Ĥ_{2, k}^{b} |
| . . . | . . . | . . . | . . . | . . . | . . . | . . . |
| l | Ĥ_{l, 1}^{b} | Ĥ_{l, 2}^{b} | . . . | Ĥ_{l, l′}^{b} | . . . | Ĥ_{l, k}^{b} |
| . . . | . . . | . . . | . . . | . . . | . . . | . . . |
| k | Ĥ_{k, 1}^{b} | Ĥ_{k, 2}^{b} | . . . | Ĥ_{k, l′}^{b} | . . . | Ĥ_{k, k}^{b} |

As a possible case, each joint user separately calculates the target correlation of any two clustering center points. For each joint user, the target correlation of any two clustering center points is the sum of the initial correlation and the reference correlation of any two clustering center points. The following Table 3 shows the k² target correlations:

TABLE 3

| | 1 | 2 | . . . | l′ | . . . | k |
|---|---|---|---|---|---|---|
| 1 | Ĥ_{1, 1}^{a} + | Ĥ_{1, 2}^{a} + | . . . | Ĥ_{1, l′}^{a} + | . . . | Ĥ_{1, k}^{a} + |
| | Ĥ_{1, 1}^{b} | Ĥ_{1, 2}^{b} | | Ĥ_{1, l′}^{b} | | Ĥ_{1, k}^{b} |
| 2 | Ĥ_{2, 1}^{a} + | Ĥ_{2, 2}^{a} + | . . . | Ĥ_{2, l′}^{a} + | . . . | Ĥ_{2, k}^{a} + |
| | Ĥ_{2, 1}^{b} | Ĥ_{2, 2}^{b} | | Ĥ_{2, l′}^{b} | | Ĥ_{2, k}^{b} |
| . . . | . . . | . . . | . . . | . . . | . . . | . . . |
| l | Ĥ_{l, 1}^{a} + | Ĥ_{l, 2}^{a} + | . . . | Ĥ_{l, l′}^{a} + | . . . | +Ĥ_{l, k}^{a} + |
| | Ĥ_{l, 1}^{b} | Ĥ_{l, 2}^{b} | | Ĥ_{l, l′}^{b} | | Ĥ_{l, k}^{b} |
| . . . | . . . | . . . | . . . | . . . | . . . | . . . |
| k | Ĥ_{k, 1}^{a} + | Ĥ_{k, 2}^{a} + | . . . | Ĥ_{k, l′}^{a} + | . . . | Ĥ_{k, k}^{a} + |
| | Ĥ_{k, 1}^{b} | Ĥ_{k, 2}^{b} | | Ĥ_{k, l′}^{b} | | Ĥ_{k, k}^{b} |

As a possible case, each joint user shares the target correlation between any two clustering center points. For any two clustering center points, the target correlation between any two clustering center points is the sum result of the average reference correlation between any two clustering center points of all joint users and the initial correlation between any two clustering center points. For example, there are N joint users, and the reference correlation between any two clustering center points of the i^{th} joint user is expressed as Ĥ_{l,l′}^{ib}, then the target correlation between any two clustering center points is

$${\hat{H}}_{l , {l}^{′}}^{a} + \frac{1}{N} {\sum }_{i = 1}^{N} {\hat{H}}_{l , {l}^{′}}^{i b} .$$

Step 204, determining the target correlation matrix corresponding to the at least two clustering center points according to the target correlation between any two clustering center points; determining a target similarity vector according to the target similarity between each of the at least two clustering center points and the plurality of non-label data; correcting target correlation matrix according to the regularization parameter and the identity matrix to determine the correction correlation matrix.

The correction correlation matrix is calculated by the Formula 4, Ĥ′=Ĥ+λIₙ.

Step 205: determining the similarity weight vector according to the correction correlation matrix and the target similarity vector, wherein the similarity weight vector includes the respective similarity weights corresponding to the at least two clustering center points.

The similarity weight vector is calculated by the Formula 5, \hat{θ}=Ĥ′⁻¹ĥ.

Step 206: for each label data of the joint user, weighting and summing the similarity between each of the at least two clustering center points and the label data according to the respective similarity weights corresponding to the at least two clustering center points to determine the weight corresponding to the label data.

The weight corresponding to each label data is calculated by the above Formula 6, \hat{r}(xⱼ)_{α}=Σᵢ₌₁^{k}\hat{θ}ₗK(xⱼ, xₗ).

Step 207: determining the data distribution similarity between the target user and the joint user according to the non-label data, the at least two clustering center points and the similarity weights corresponding to the at least two clustering center points.

The data distribution similarity between the joint user and the target user is calculated by the above Formula 7,

$${\hat{L}}_{s} = \frac{1}{n} {\sum }_{i = 1}^{n} log [ {\hat{θ}}_{l , s} K ( {x}_{i} , {x}_{l} ) ] .$$

Step 208: taking the joint user corresponding to the data distribution similarity meeting the joint learning conditions as a target joint user, and constructing a joint learning model according to the label data of the target joint user and the respective weights of the label data.

According to the above technical solution, this embodiment has the following beneficial effects: a plurality of non-label data corresponding to a business task of a target user are clustered, clustering center points are determined, target similarity between the clustering center points and the plurality of non-label data and initial correlation between any two clustering center points are determined, thus obtaining description information of the non-label data and ensuring data privacy and security. According to the clustering center points, the target similarity between clustering center points and the plurality of non-label data, the initial correlation between any two clustering center points and the reference correlation between any two clustering center points, the similarity weights corresponding to all clustering center points are determined, the similarity between label data and all clustering center points is weighted according to the similarity weights corresponding to all clustering center points, and the corresponding weights of label data are determined. Non-label data is migrated to label data, which realizes data migration and ensures the amount of data. Then, based on the data distribution similarity between joint users and target users, joint users are selected. Based on a plurality of label data of the joint users with high similarity of data distribution and their corresponding weights, a joint learning model is built. The joint learning model is configured to perform the business tasks of target users, which can complete the business tasks of the target users and ensure the accuracy of the model.

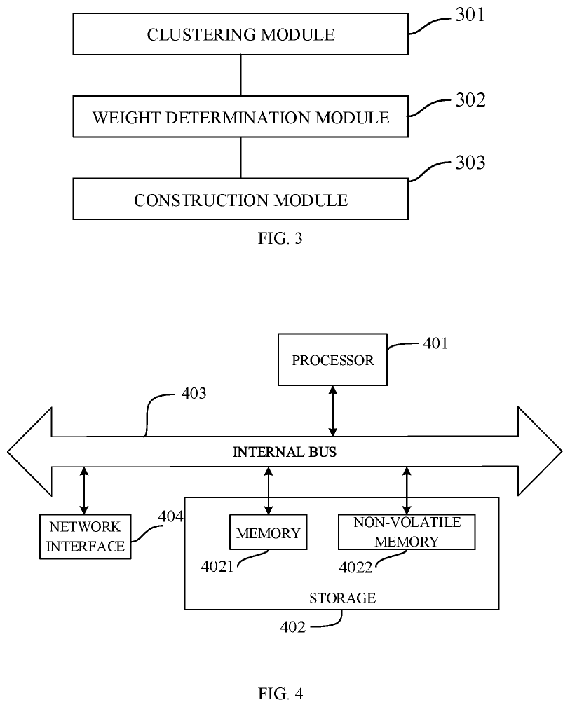

Refer to FIG. 3, based on the same concept as the method embodiment of the present application, the embodiment of the present application also provides a business task execution device, which includes:
a clustering module 301 configured to cluster a plurality of non-label data corresponding to a business task of a target user to determine at least two clustering center points;
a weight determination module 302 configured to determine the respective weights of the label data of the joint user according to the at least two clustering center points and the plurality of non-label data, wherein the plurality of label data correspond to the business task;
a construction module 303 configured to construct a joint learning model according to the label data of the joint user and the respective weights of the label data, wherein the joint learning model is configured to execute the business task of the target user.

In an embodiment of the present application, the weight determination module 302 includes a similarity determination unit, a first weight determination unit and a second weight determination unit; wherein,
the similarity determination unit is configured to determine the target similarity between each of the at least two clustering center points and the plurality of non-label data according to the at least two clustering center points and the plurality of non-label data;
the first weight determining unit is configured to determine the similarity weights corresponding to the at least two clustering center points according to the at least two clustering center points, the target similarities between the at least two clustering center points and the non-label data and the label data of the joint users;
the second weight determining unit is configured to determine the weights corresponding to the label data of the joint user according to the similarity weights corresponding to the at least two clustering center points.

An embodiment of the present application further comprises a correlation determination module;
the correlation determination module is configured to determine that initial correlation between any two clustering center centers according to any two of the at least two clustering center points and the plurality of non-label data;
the first weight determination unit includes a first correlation determination subunit, a second correlation determination subunit and a first weight determination subunit; wherein,
the first correlation determination subunit is configured to determine the reference correlation between any two clustering center points according to the two clustering center points and the label data of the joint users;
the second correlation determination subunit is configured to determine the target correlation between any two clustering center points according to the initial correlation and reference correlation between any two clustering center points;
the first weight determination subunit is configured to determine the similarity weights corresponding to the at least two clustering center points according to the target correlation between any two clustering center points and the target similarity between each of the at least two clustering center points and the plurality of non-label data.

In one embodiment, the second weight determination unit includes a second weight determination subunit; wherein,
the second weight determination subunit is configured to weight and sum the similarity between each of the at least two clustering center points and the label data according to the respective similarity weights corresponding to the label data of the joint users, so as to determine the weights corresponding to the label data.

In one embodiment, the device further includes a similarity calculation module, an importance calculation module and an adjustment module; wherein,
the similarity calculation module is configured to determine the data distribution similarity between the target user and the joint user according to the non-label data, the at least two clustering center points and the similarity weights corresponding to the at least two clustering center points;
the importance calculation module is configured to determine the importance of each joint user according to the similarity of data distribution between each joint user and the target user;
the adjustment module is configured to adjust the joint learning model according to the respective importance of each joint user.

In one embodiment, the first weight determination subunit is configured to perform the following steps:
determining a target correlation matrix corresponding to at least two clustering center points according to the target correlation between any two clustering center points;
determining a target similarity vector according to the target similarity between each of the at least two clustering center points and the plurality of non-label data;
correcting the target correlation matrix according to the regularization parameter and identity matrix to determine a correction correlation matrix;
determining a similarity weight vector according to the correction correlation matrix and the target similarity vector, wherein the similarity weight vector includes the similarity weights corresponding to the at least two clustering center points respectively.

In one embodiment, the correction correlation matrix is obtained by summing the target correlation matrix and the result of multiplying the regularization parameter by the identity matrix;
the similarity weight vector is obtained by multiplying the reciprocal of the correction correlation matrix with the similarity vector;
the target correlation is obtained by adding the initial correlation and the reference correlation between any two clustering center points;
the target similarity is obtained by averaging the respective target similarities between the label data and the clustering center points;
the initial correlation is obtained by correcting the average value of target similarity product values corresponding to each of the non-label data based on the target probability distribution weight, and the target similarity product values are obtained by multiplying the target similarity between each of the any two clustering center points and the non-label data;

The reference correlation is obtained by correcting the average value of the reference similarity product values corresponding to the label data based on the reference probability distribution weight, and the reference similarity product values are obtained by multiplying the reference similarities between the any two clustering center points and the label data;
wherein the sum of the target probability distribution weight and the reference probability distribution weight is equal to 1, and the reference similarity and the target similarity are calculated based on the same kernel function.

In one embodiment, each of the joint users shares the target correlation between any two clustering center points;
the target correlation is determined based on the initial correlation between any two clustering center points and the reference correlation between any two clustering center points of each joint user.

In one embodiment, the clustering center point is different from any one of the plurality of non-label data.

FIG. 4 is a structural diagram of electronic equipment provided by an embodiment of the present application. At the hardware level, the electronic equipment includes a processor 401, a storage 402 storing execution instructions, and optionally an internal bus 403 and a network interface 404. The storage 402 may include a memory 4021, such as a Random-Access Memory (RAM), or a non-volatile memory 4022, such as at least one disk memory. The processor 401, the network interface 404 and the storage 402 can be connected to each other through an internal bus 403, which can be an ISA (Industry Standard Architecture) bus, a PCI (Peripheral Component Interconnect) bus, an EISA (Extended Industry Standard Architecture) bus and the like; the internal bus 403 can be divided into an address bus, a data bus, a control bus, etc. For convenience, only one bidirectional arrow is shown in FIG. 4, but it does not mean that there is only one bus or one type of bus. Of course, the electronic equipment may also include hardware required by other services. When the processor 401 executes the execution instructions stored in the storage 402, the processor 401 executes the method in any one of the embodiments of the present application, and at least it is configured to execute the method shown in FIG. 1 or FIG. 2.

In a possible way, the processor reads the corresponding execution instructions from the nonvolatile memory into the memory and then runs the instructions, and can also obtain the corresponding execution instructions from other devices to form a business task execution device at the logical level. The processor executes the execution instructions stored in the memory to realize a business task execution method provided in any embodiment of the present application through the executed execution instructions.

The processor may be an integrated circuit chip with signal processing capability. In the implementation process, each step of the above method can be completed by the hardware integrated logic circuit in the processor or the instructions in the form of software. The above-mentioned processor can be a general-purpose processor, including a Central Processing Unit (CPU), a Network Processor (NP), etc. It can also be a Digital Signal Processor (DSP), an application specific integrated circuit (ASIC), a Field-Programmable Gate Array (FPGA) or other programmable logic devices, discrete gate or transistor logic devices, and discrete hardware components. The methods, steps and logic block diagrams disclosed in the embodiments of the present application can be implemented or executed. The general-purpose processor may be a microprocessor or the processor may be any conventional processor or the like.

The embodiment of the present application also provides a computer-readable storage medium including execution instructions. When the processor of the electronic equipment executes the execution instructions, the processor executes the method provided in any one of the embodiments of the present application. The electronic equipment can specifically be electronic equipment as shown in FIG. 4; the execution instructions are compute programs corresponding to that business task execution device.

Those skilled in the art should understand that embodiments of the present application can be provided as methods or computer program products. Therefore, the present application can take the form of an entirely hardware embodiment, an entirely software embodiment, or a combination of software and hardware.

Each embodiment of the present application is described in a progressive manner, and the same and similar parts between each embodiment can be referred to each other. Each embodiment focuses on the differences from other embodiments. Especially, for the device embodiment, because it is basically similar to the method embodiment, the description is relatively simple, and reference may be made to the partial description of the method embodiment for the relevant parts.

It should also be noted that the terms “include”, “including” or any other variant thereof are intended to cover non-exclusive inclusion, so that a process, method, commodity or equipment that includes a series of elements includes not only those elements, but also other elements not explicitly listed, or elements inherent to such process, method, commodity or equipment. Without further limitation, the element defined by the sentence “including a . . . ” does not exclude that there are other identical elements in the process, method, commodity or equipment including the element.

The above description is only an example of the present application, and is not intended to limit the present application. Various modifications and variations of the present application are possible to those skilled in the art. Any modification, equivalent substitution, improvement and the like made within the spirit and principle of the present application should be included within the scope of the claims of the present application.

What is claimed is:

1. A business task execution method, comprising the following steps of:
clustering a plurality of non-label data corresponding to a business task of a target user, so as to determine at least two clustering center points;
determining respective weights corresponding to a plurality of label data of a joint user according to the at least two clustering center points and the plurality of non-label data, wherein the plurality pieces of label data correspond to the business task;
constructing a joint learning model according to the plurality of label data of each joint user and the respective weights corresponding to the plurality of label data, wherein the joint learning model is used for executing the business task of the target user.

2. The method according to claim 1, wherein the step of determining respective weights corresponding to a plurality of label data of a joint user according to the at least two clustering center points and the plurality of non-label data comprises:
determining a target similarity between each of the at least two clustering center points and the plurality of non-label data according to the at least two clustering center points and the plurality of non-label data;
determining respective similarity weighs corresponding to the at least two clustering center points according to the at least two clustering center points, the target similarity between each of the at least two clustering center points and the plurality of non-label data and the plurality of label data of the joint user; and
determining the respective weights corresponding to the plurality of label data of the joint user according to the respective similarity weights corresponding to the at least two clustering center points.

3. The method according to claim 2, further comprising:
determining an initial correlation between any two clustering center points according to any two of the at least two clustering center points and the plurality of non-label data;
wherein the step of determining respective similarity weighs corresponding to the at least two clustering center points according to the at least two clustering center points, the target similarity between each of the at least two clustering center points and the plurality of non-label data and the plurality of label data of the joint user comprises:
determining a reference correlation between the any two clustering center points according to the any two clustering center points and the plurality of label data of the joint user;
determining a target correlation between the any two clustering center points according to the initial correlation and the reference correlation between the any two clustering center points; and
determining the respective similarity weights corresponding to the at least two clustering center points according to the target correlation between the any two clustering center points and the target similarity between each of the at least two clustering center points and the plurality of non-label data.

4. The method according to claim 3, further comprising:
determining a data distribution similarity between the target user and the joint user according to the non-label data, the at least two clustering center points and the respective similarity weights corresponding to the at least two clustering center points;
determining the respective importance of each joint user according to the data distribution similarity between each joint user and the target user; and
adjusting the joint learning model according to the respective importance of each joint user.

5. The method according to claim 3, wherein the step of determining the respective similarity weights corresponding to the at least two clustering center points according to the target correlation between the any two clustering center points and the target similarity between each of the at least two clustering center points and the plurality of non-label data comprises:
determining a target correlation matrix corresponding to at least two clustering center points according to the target correlation between the any two clustering center points;
determining a target similarity vector according to the target similarity between each of the at least two clustering center points and the plurality of non-label data;
correcting the target correlation matrix according to a regularization parameter and an identity matrix to determine a correction correlation matrix;
determining a similarity weight vector according to the correction correlation matrix and the target similarity vector, wherein the similarity weight vector comprises respective similarity weights corresponding to the at least two clustering center points.

6. The method according to claim 5, wherein the correction correlation matrix is obtained by summing the target correlation matrix and a result of multiplying the regularization parameter by the identity matrix;
the similarity weight vector is obtained by multiplying the reciprocal of the correction correlation matrix with the similarity vector;
the target correlation is obtained by adding the initial correlation and the reference correlation between the any two clustering center points;
the target similarity is obtained by averaging the target similarity between each of the plurality of label data and the clustering center points;
the initial correlation is obtained by correcting an average value of respective target similarity product values corresponding to the non-label data based on the target probability distribution weight, and the target similarity product values are obtained by multiplying the target similarity between each of the any two clustering center points and the non-label data;
the reference correlation is obtained by correcting the average value of respective reference similarity product values corresponding to the label data based on the reference probability distribution weight, and the reference similarity product values are obtained by multiplying the reference similarity between each of the any two clustering center points and the label data;
wherein a sum of the target probability distribution weight and the reference probability distribution weight is equal to 1, and the reference similarity and the target similarity are calculated based on a same kernel function.

7. The method according to claim 3, wherein each of the joint users shares the target correlation between the any two clustering center points;
the target correlation is determined based on the initial correlation between the any two clustering center points and the reference correlation between the any two clustering center points of each of the joint users.

8. The method according to claim 2, wherein, the step of determining the respective weights corresponding to the plurality of label data of the joint user according to the respective similarity weights corresponding to the at least two clustering center points comprises:
for each of the label data of the joint user, weighting and summing the similarity between each of the at least two clustering center points and the label data according to the respective similarity weights corresponding to the at least two clustering center points to determine the weights corresponding to the label data.

9. The method according to claim 1, wherein the clustering center point is different from any one of the plurality of non-label data.

10. A business task execution device, comprising:
a clustering module configured to cluster a plurality of non-label data corresponding to a business task of a target user to determine at least two clustering center points;
a weight determination module configured to determine respective weights of a plurality of label data of a joint user according to the at least two clustering center points and the plurality of non-label data, wherein the plurality of label data correspond to the business task;
a construction module configured to construct a joint learning model according to the plurality of label data of the joint user and the respective weights of the plurality of label data, wherein the joint learning model is used for executing the business task of the target user.
